(19) United States
(12) Patent Application Publication
(10) Pub. No.: US 2008/0067715 A1
(43) Pub. Date: Mar. 20, 2008

(54) METHOD OF MANUFACTURING CASE STRUCTURE HAVING ANTENNA

(75) Inventor: Jae Suk SUNG, Gyunggi-do (KR)

Correspondence Address: LOWE HAUPTMAN HAM & BERNER, LLP, 1700 DIAGONAL ROAD, SUITE 300, ALEXANDRIA, VA, 22314, US

(73) Assignee: SAMSUNG ELECTRO-MECHANICS CO., LTD., GYUNGGI-DO (KR)

(21) Appl. No.: 11/855,347

(22) Filed: Sep. 14, 2007

(30) Foreign Application Priority Data
Sep. 15, 2006 (KR) 10-2006-89425
May 10, 2007 (KR) 10-2007-45576

(51) Int. Cl. B29C 45/14

(52) U.S. Cl. 264/279

(57) ABSTRACT

A method of manufacturing a case structure having an antenna, the method including: providing a carrier film; forming an antenna radiator formed of a metal foil on at least one surface of the carrier film; inserting the carrier film having the antenna radiator formed thereon into a mold formed in a desired shape of a case structure; and injecting a molding material into the mold.

### CROSS-REFERENCE TO RELATED APPLICATIONS

This application claims the priority of Korean Patent Application No. 2006-89425 filed on Sep. 15, 2006, and 2007-45576 filed on May 10, 2007, in the Korean Intellectual Property Office, the disclosure of which is incorporated herein by reference.

### BACKGROUND OF THE INVENTION

1. Field of the Invention

The present invention relates to an antenna, and more particularly, to a method of manufacturing an internal antenna to be integrated into a case.

2. Description of the Related Art

Recently, mobile telecommunication terminals such as global positioning systems (GPSs), personal digital assistants (PDAs), cellular phones, wireless laptop computers have been in wide use and increasingly need to be reduced in weight and size. To meet this demand, a focus has been placed on the manufacture of a multifunctional and less bulky mobile telecommunication terminal. Notably, this trend is prevailing in an antenna, one of major essential components in the mobile telecommunication terminal.

In general, an exterior antenna such as a rod antenna and a helical antenna in the mobile telecommunication terminal is protruded outwardly from the terminal in a certain length, thereby hardly miniaturizable and less portable. Also, the exterior antenna, when dropped off, is susceptible to damage.

On the contrary, an internal antenna mounted inside the mobile telecommunication terminal, such as a surface mounted chip antenna, may risk less damage unlike the exterior antenna, however still hard be reduced in size due to physical size thereof.

Of late, an antenna radiator is directly formed in one of a terminal case and an antenna base to maximize spatial use.

FIG. 1A is a perspective view illustrating a conventional internal antenna of a mobile telecommunication terminal and FIG. 1B is a schematic cross-sectional view illustrating the internal antenna mounted on the mobile telecommunication terminal.

Referring to FIG. 1A, a plastic base 11 for the internal antenna is formed by injection and a metal plate-shaped, radiator 13 with a pattern formed thereon is formed by a pressing process. Then the base 11 and the radiator 13 are integrated into one by fusion.

However, the base 11 and the radiator 13 installed inside the terminal basically require a certain space, thus hindering miniaturization of the terminal.

The radiator 13 may be formed on the base 11 by printing a conductive ink. However, in this method, since the antenna base is formed of plastic, the printing should be carried out at a certain temperature or less where the plastic is not deformed. The antenna pattern formed on the base should be printed by using a low-temperature paste. Therefore, in this case, the paste is selected with much limitation, considering printability and adhesiveness.

Moreover, to ensure printability and adhesiveness of the conductive ink, not only a conductive material but also an organic material is added to the conductive ink. Here, the organic material is removable when the conductive ink is treated at a high temperature, but remains unremoved when the conductive ink is treated at a low temperature. The conductive ink is not treatable at a high temperature due to use of polymer as the base of the antenna, thus leaving the organic material unremoved from the conductive ink even after the antenna radiator is formed. This lowers electrical conductivity, which is the most important characteristic as an antenna radiator, thereby deteriorating radiation characteristics of the antenna.

In addition, printing the conductive ink on the three-dimensional antenna base entails an intricate process.

### SUMMARY OF THE INVENTION

An aspect of the present invention provides a radiator of an internal antenna which is reduced in size and high in electrical conductivity.

According to an aspect of the present invention, there is provided a method of manufacturing a case structure having an antenna, the method including: providing a carrier film; forming an antenna radiator formed of a metal foil on at least one surface of the carrier film; inserting the carrier film having the antenna radiator formed thereon into a mold formed in a desired shape of a case structure; and injecting a molding material into the mold.

The method may further include forming a protective layer on the carrier film to cover the antenna radiator, between the forming an antenna radiator and the inserting the carrier film into a mold.

The method may further include forming the carrier film having the antenna radiator formed thereon, in a three-dimensional shape according to a shape of the mold where the antenna radiator is embedded, between the forming an antenna radiator and the inserting the carrier film into a mold.

The forming an antenna radiator may include: cutting the metal foil into a desired shape of the antenna radiator; and attaching the cut antenna radiator on the at least one surface of the carrier film.

The forming an antenna radiator may include: attaching the metal foil on the at least one surface of the carrier film; and cutting the attached metal foil into a desired shape of the antenna radiator.

The forming an antenna radiator may include: forming a resist film with an antenna pattern on one surface of the metal foil; etching an exposed portion of the metal foil; and removing the resist film.

According to another aspect of the present invention, there is provided a method of manufacturing a case structure having an antenna, the method including: providing a plurality of carrier films; forming an antenna radiator formed of a metal foil on one surface of each of the carrier films; depositing the plurality of carrier films having the antenna radiators formed thereon; inserting the deposited carrier films into a mold in the shape of a case of a mobile telecommunication terminal; and injecting a molding material into the mold and forming the case of the mobile telecommunication terminal to be integrally combined with the deposited carrier films.

The plurality of carrier films may be formed of different materials from one another.

The antenna radiators formed on the plurality of carrier films, respectively, may be formed of different metals from one another.

The antenna radiators formed on the carrier films, respectively, may have different shapes from one another.

The method may further include coating a top of the deposited carrier films with ceramic, between the depositing the carrier films and the inserting the deposited carrier films into a case of a mobile telecommunication terminal.

### BRIEF DESCRIPTION OF THE DRAWINGS

The above and other aspects, features and other advantages of the present invention will be more clearly understood from the following detailed description taken in conjunction with the accompanying drawings, in which:

FIG. 1A is a perspective view illustrating a conventional internal antenna and FIG. 1B is a schematic cross-sectional view illustrating a terminal having an internal antenna mounted thereon;

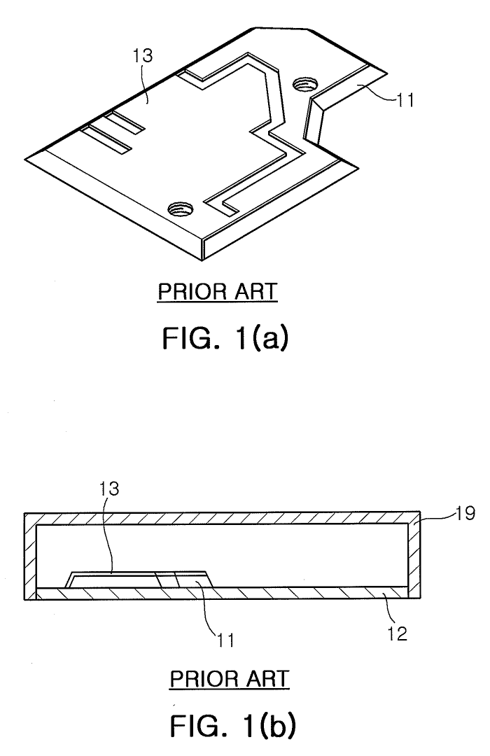

FIGS. 2A through 2E are a flow chart illustrating a method of manufacturing a case structure having an antenna attached thereon according to an exemplary embodiment of the invention;

FIGS. 3A through 3D are a procedural view illustrating a process for forming a carrier film having an antenna radiator attached thereon according to an embodiment of the invention;

FIGS. 4A through 4D are a procedural view illustrating a process for forming a carrier film having an antenna radiator attached thereon according to another embodiment of the invention;

FIGS. 5A through 5D are a procedural view illustrating a process for manufacturing a deposited antenna according to an exemplary embodiment of the invention; and

FIGS. 6A through 6D are a procedural view illustrating a process for forming an antenna radiator according to an exemplary embodiment of the invention.

### DETAILED DESCRIPTION OF THE PREFERRED EMBODIMENT

Exemplary embodiments of the present invention will now be described in detail with reference to the accompanying drawings.

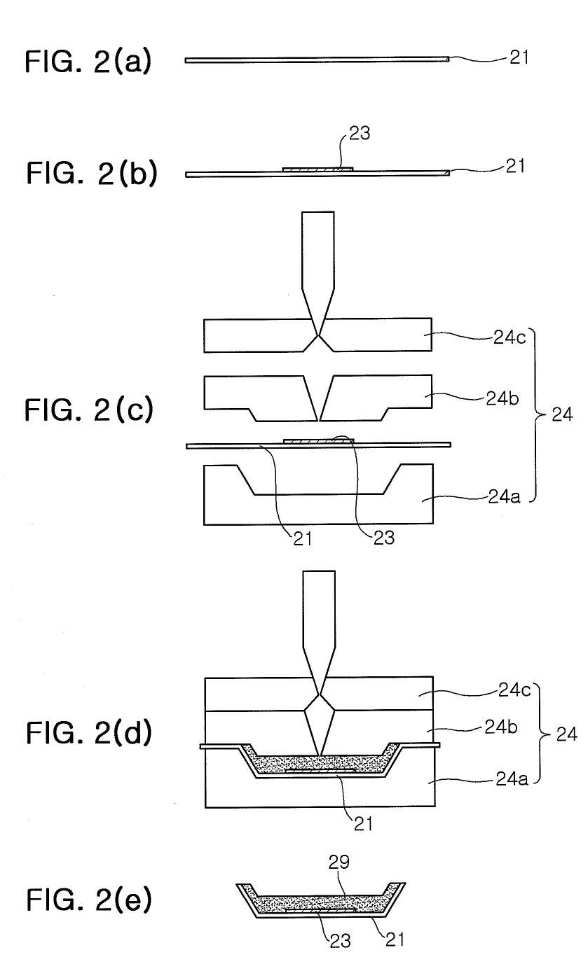

FIGS. 2A through 2D are a cross-sectional view illustrating a method of manufacturing a case structure having an antenna for a mobile telecommunication terminal attached thereon according to an exemplary embodiment of the invention.

Referring to FIG. 2A, a carrier film 21 is provided.

The carrier film 21 has an antenna pattern on at least one surface thereof. Also, the carrier film 21 is inserted into a mold to go through an in-molding process. Thus, there is a need to adopt a material which is not deformed significantly due to pressure and temperature during the molding process and integratable into a case of the mobile telecommunication terminal.

The carrier film may be formed of a thin insulating polymer material.

Referring to FIG. 2B, an antenna radiator 23 composed of a metal foil is formed on the carrier film 21.

Examples of materials for the metal foil include a gold foil, a silver foil, a copper foil, an aluminum foil and the like.

This metal foil, when employed as the antenna radiator, ensures considerably higher antenna efficiency due to high purity thereof.

In general, in forming the antenna radiator by screen printing, a great amount of organic material is contained in the paste to improve printability and adhesiveness to the carrier film. Moreover, in-molding should be performed at a low temperature where plastics are not deformed, thus necessitating a room-temperature paste containing the organic material. This as a result reduces conductivity of electrodes and degrades antenna efficiency. These drawbacks may be overcome by employing the metal foil as the antenna radiator according to the present embodiment.

Although not illustrated in the drawings, the antenna radiator 23 includes a feeding terminal and may further include a connecting terminal such as a ground terminal to connect to an external circuit.

FIG. 2C illustrates the carrier film 21 having an antenna radiator 23 formed thereon, disposed in a mold 24. The mold 24 includes a first part 24a providing a bottom of the mold, in contact with the carrier film 21, a second part 24b injected with a molding material and providing a top of the mold, and a third part 24c connected to a reservoir of the molding material through a nozzle. The carrier film 21 is inserted between the first part 24a and the second part 24b. The antenna radiator 23 formed on the carrier film is disposed in direct contact with the molding material during molding.

FIG. 2D illustrates the first to third parts 24a to 24c of the mold bonded together. Here, the molding material is injected through a nozzle into the mold 24 under a certain pressure. The pressure transforms the carrier film 21 into the first part 24a of the mold. Then the molding material injected into the mold is filled between the second part 24b and the first part 24a of the mold.

FIG. 2E illustrates a film antenna having an integrated structure of the carrier film 21 where the antenna radiator 23 is formed and a case 29 of the mobile telecommunication terminal, after the mold 24 is compressed, cooled and cured.

In the present embodiment, the carrier film 21 is disposed on an outer periphery of the case 29 of the mobile telecommunication terminal and the antenna radiator 23 is disposed between the carrier film 21 and the case 29 of the mobile telecommunication terminal.

However, the antenna radiator 23 may be disposed on an outer surface of the carrier film 21. In this case, a protective layer may be formed to cover the antenna radiator 23.

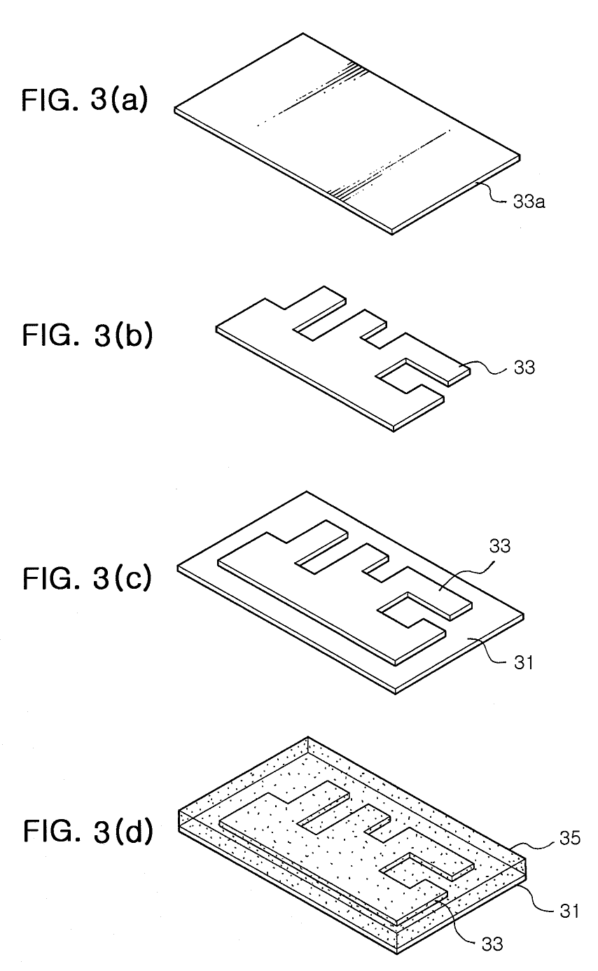

FIGS. 3A through 3D are a procedural view illustrating a process for forming a carrier film having an antenna radiator attached thereon according to an exemplary embodiment of the invention.

FIG. 3A illustrates a process of providing a metal foil 33a.

FIG. 3B illustrates a process of cutting the metal foil 33a into a desired shape to obtain a metal foil antenna radiator 33. This metal foil antenna radiator is cut via an automatic cutter, thus beneficially leading to automation and mass-production and reducing manufacturing costs.

FIG. 3C is a cross-sectional view illustrating a process of attaching the cut antenna radiator 33 on the carrier film 31.

General metal foil has an adhesive material on one surface thereof to be easily attached to others. Thus in this process, the metal foil 33 is primarily bonded to the carrier film 31 using the adhesive components. To ensure stronger bonding, a buffer layer may be formed between the metal foil 33 and the carrier film 31.

FIG. 3D illustrates a process of forming the protective layer 35 on the carrier film 31 to cover the antenna radiator 33.

The protective layer 35 of the present embodiment serves to protect the antenna radiator 33 exposed to an external atmosphere. The protective layer 35 is formed of an electrically insulating material thereby not to greatly affect radiation characteristics of the antenna radiator 33. Here, a known insulating material for passivation may be adopted.

Also, optionally, at least one of graphics and letters may be additionally printed on the protective layer 35 to give aesthetic appearance to the mobile telecommunication terminal. Also, necessary letters such as company logos may be added to the protective layer 35.

The protective layer protects the antenna radiator 33 or prevents the metal foil from floating during the process. To this end, the protective layer is formed by thermal compression, thereby helpfully allowing the metal foil to be attached on the carrier film stably.

Furthermore, the protective layer 35 may be formed of a non-transparent material to prevent an internal circuit pattern of the antenna from being exposed outwardly. This assures protection of the know-how utilized to develop the antenna.

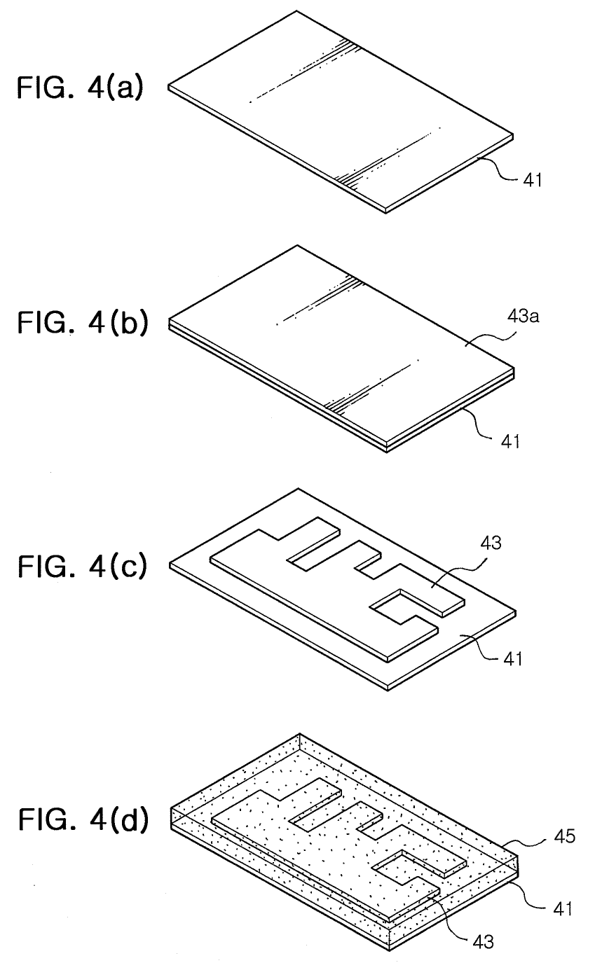

FIGS. 4A through 4D are a procedural view illustrating a process of forming a carrier film having an antenna radiator attached thereon according to another exemplary embodiment of the invention.

FIG. 4A illustrates a process of providing a carrier film 41.

FIG. 4B illustrates a process of attaching a metal foil 43a on the carrier film 41.

FIG. 4C illustrates a process of cutting the metal foil 43a attached on the carrier film 41 into a desired shape of the antenna radiator 43.

In a case where the metal foil is cut first and then attached on the carrier film 41, the metal foil 43a may be misaligned with the carrier film 41. According to the present embodiment, a large-scale metal foil 43a is attached on one surface of the carrier film 41 and only the metal foil 43a is cut by an automatic cutter. Here, a height of a cutting blade is adequately adjusted to cut only the overlying metal foil 43a and not to cut the underlying carrier film 41. The present embodiment notably contributes to mass production and automation, thereby reducing manufacturing costs and unit costs.

FIG. 4D illustrates a process of forming the protective layer 45 on the carrier film 41 to cover the antenna radiator 43.

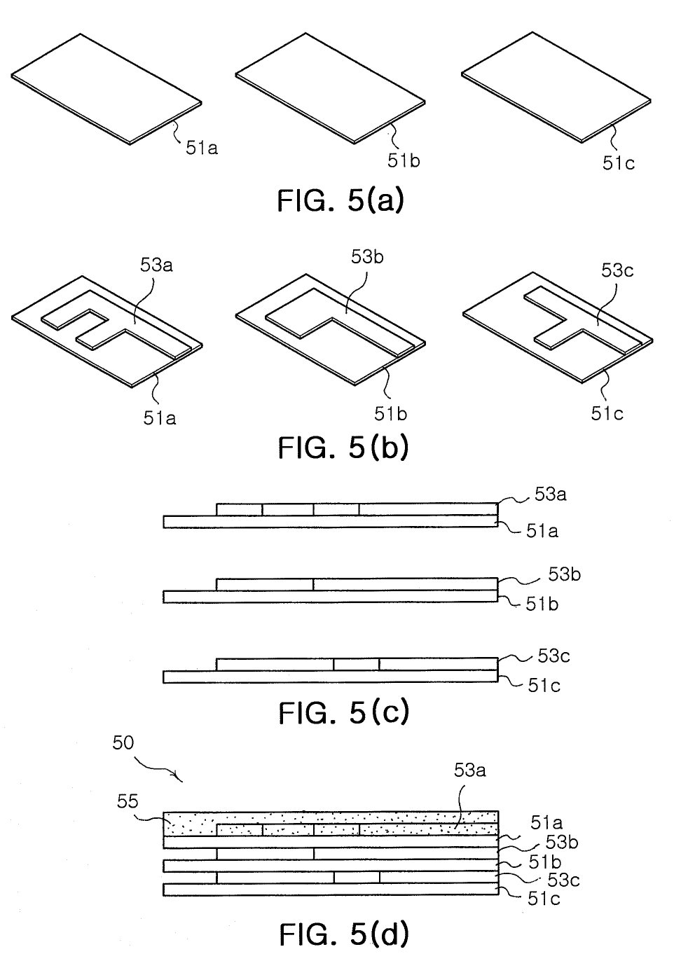

FIGS. 5A through 5D illustrate a method of manufacturing a deposited antenna according to an exemplary embodiment of the invention.

First, a plurality of carrier films are provided as shown in FIG. 5A. Then, antenna radiators 53a, 53b, and 53c composed of different metal foils from one another are formed on carrier films 51a, 51b and 51c, respectively, as shown in FIG. 5B.

The carrier films having the antenna radiators formed thereon, respectively, are deposited as shown in FIG. 5C and pressurized, and then a protective layer 55 is formed to cover an antenna radiator 53a exposed at a top of the deposited carrier films.

The deposited antenna manufactured in this fashion can be integrated into the case of the mobile telecommunication terminal by in-molding as described above.

In general, the internal antenna for the mobile telecommunication terminal according to the present embodiment is much thinner than a conventional antenna structure. Thus, a multilayer structure including additional carrier films and antenna patterns according to the present embodiment satisfies sufficient conditions for miniaturization.

Furthermore, the internal antenna 50 according to the present embodiment may additionally include two carrier films 51b and 51c to additionally form two antenna patterns 53b and 53c thereon. Overall, the internal antenna 50 may have three antenna patterns. Therefore, each of the antenna patterns 51a, 51b and 51c may be designed differently to ensure a multi-band antenna covering at least three resonance frequency bandwidths.

Alternatively, two adjacent ones of the three antenna patterns may be designed in a symmetrical configuration to realize an antenna structure including a balanced antenna.

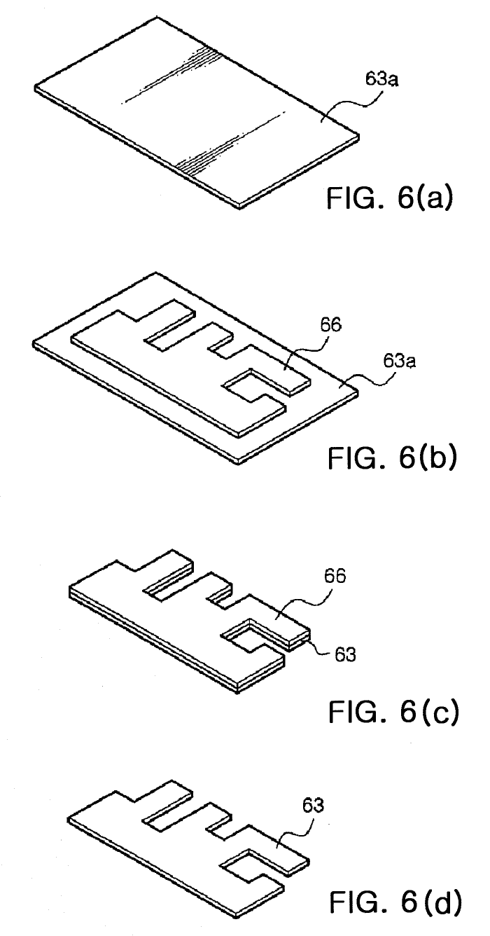

FIGS. 6A through 6D are a procedural view illustrating a process of forming an antenna radiator according to an exemplary embodiment of the invention.

FIG. 6A illustrates a process of providing a metal foil 63a.

The metal foil may adopt a gold film, a silver film, a copper film and an aluminum film. In this process, foreign materials are removed from surfaces of the metal foil.

FIG. 6B illustrates a process of forming a resist film 66 in the shape of an antenna radiator on one surface of the metal foil 63a.

The resist film 66 may be a photo resist film formed of a photosensitive material.

To form the photo resist film in the shape of an antenna pattern, first a photo resist film is formed on the one surface of the metal foil and a photo mask is formed on the photo resist film. In the photo mask, a portion corresponding to a desired shape of the antenna pattern may be transparent while the other portion may be non-transparent.

When an infrared ray is irradiated on the photo resist film covered with the photo mask, an area of the photo resist corresponding to the transparent portion of the photo mask is cured and the remaining area is not cured. This process is referred to as photolithography. With the photolithography completed, the photo mask is removed.

When the photolithography is completed, the metal foil having the photo resist film formed thereon is placed into a developer to remove the uncured area of the photo resist film except for the cured area of the photo resist film. This process is referred to as development.

The development, when completed, allows an antenna-patterned photoresist film 66 to be formed on the metal foil 63a.

FIG. 6C illustrates a process of etching an exposed portion of the metal foil. In this etching, an etchant may be employed to dissolve the metal foil. The etching, when completed, allows the resist film 66 with a desired antenna pattern and an antenna radiator 63 to be deposited.

FIG. 6D illustrates the antenna radiator 63 obtained by removing the resistor film.

The resist film may be removed using a remover.

According to the present embodiment, the antenna radiator may be formed by lithography, thereby ensuring more precise pattern to be formed stably.

As set forth above, according to exemplary embodiments of the invention, an internal antenna for a mobile telecommunication terminal can be manufactured with high conductivity, good efficiency and smaller size.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of manufacturing a case structure having an antenna, the method comprising:
providing a carrier film;
forming an antenna radiator formed of a metal foil on at least one surface of the carrier film;
inserting the carrier film having the antenna radiator formed thereon into a mold formed in a desired shape of a case structure; and
injecting a molding material into the mold.

2. The method of claim 1, further comprising forming a protective layer on the carrier film to cover the antenna radiator, between the forming an antenna radiator and the inserting the carrier film into a mold.

3. The method of claim 1, further comprising forming the carrier film having the antenna radiator formed thereon, in a three-dimensional shape according to a shape of the mold where the antenna radiator is embedded, between the forming an antenna radiator and the inserting the carrier film into a mold.

4. The method of claim 1, wherein the forming an antenna radiator comprises:
cutting the metal foil into a desired shape of the antenna radiator; and
attaching the cut antenna radiator on the at least one surface of the carrier film.

5. The method of claim 1, wherein the forming an antenna radiator comprises:
attaching the metal foil on the at least one surface of the carrier film; and
cutting the attached metal foil into a desired shape of the antenna radiator.

6. The method of claim 1, wherein the forming an antenna radiator comprises:
forming a resist film with an antenna pattern on one surface of the metal foil;
etching an exposed portion of the metal foil; and
removing the resist film.

7. A method of manufacturing a case structure having an antenna, the method comprising:
providing a plurality of carrier films;
forming an antenna radiator formed of a metal foil on one surface of each of the carrier films;
depositing the plurality of carrier films having the antenna radiators formed thereon;
inserting the deposited carrier films into a mold in the shape of a case of a mobile telecommunication terminal; and
injecting a molding material into the mold and forming the case of the mobile telecommunication terminal to be integrally combined with the deposited carrier films.

8. The method of claim 7, wherein the plurality of carrier films are formed of different materials from one another.

9. The method of claim 7, wherein the antenna radiators formed on the plurality of carrier films, respectively, are formed of different metals from one another.

10. The method of claim 7, wherein the antenna radiators formed on the carrier films, respectively, have different shapes from one another.

11. The method of claim 7, further comprising coating a top of the deposited carrier films with ceramic, between the depositing the carrier films and the inserting the deposited carrier films into a case of a mobile telecommunication terminal.
